(19) United States
(12) Patent Application Publication
(10) Pub. No.: US 2014/0337213 A1
(43) Pub. Date: Nov. 13, 2014

(54) AUTOMATED TELLER MACHINE ENABLING VIDEO CONSULTATION WITH CONSULTANT DURING FINANCIAL TRANSACTIONS AND TRANSACTION METHOD USING THE SAME

(71) Applicant: Nautilus Hyosung Inc., Seoul (KR)

(72) Inventors: Bo Ik CHANG, Seongnam-si (KR); Sung Suk HONG, Seoul (KR)

(73) Assignee: Nautilus Hyosung Inc., Seoul (KR)

(21) Appl. No.: 14/055,684

(22) Filed: Oct. 16, 2013

(30) Foreign Application Priority Data
May 9, 2013 (KR) 10-2013-0052476

(51) Int. Cl. G06Q 20/10

(52) U.S. Cl. CPC G06Q 20/1085
USPC 705/43

(57) ABSTRACT

Disclosed is an automated teller machine (ATM) which includes a financial transaction input unit to receive input of a financial transaction request, a first communication unit to communicate with a first server to process at least part of a plurality of steps corresponding to the financial transaction request, a consulting service input unit to receive input of a request for a consulting service associated with the financial transaction request in the plurality of steps, an identification unit to identify a step in which the request for the consulting service is input in response to the consulting service request among the steps, a generation unit to generate financial transaction information corresponding to the identified step, and a second communication unit to request a consulting service associated with the identified step to a second server based on the financial transaction information.

### CROSS-REFERENCE TO RELATED APPLICATION

This application claims the priority benefit of Korean Patent Application No. 10-2013-0052476, filed on May 9, 2013, in the Korean Intellectual Property Office, the disclosure of which is incorporated herein by reference.

### BACKGROUND

1. Field of the Invention

The present invention relates to an automated teller machine (ATM) enabling video consultation with a consultant during financial transactions and a transaction method using the same.

2. Description of the Related Art

Generally, an automated teller machine (ATM) is a computerized device that enables basic financial transactions, such as depositing and withdrawing cash and check, regardless of time and place using a card or bankbook without the need for a cashier, human clerk or bank teller.

ATMs may be divided into a withdrawal machine, a deposit machine, and a withdrawal and deposit machine based on deposit and withdrawal functions, and have evolved to include many other functions, such as depositing and withdrawing not only cash but also check, updating passbooks, paying routine bills, fees and taxes through the electronic billing system, or purchasing tickets.

When people are too busy to go to a financial institution, such as a bank, people may need to open a bank account and consult about an insurance using an ATM. Accordingly, there is need for a new system which enables a customer to easily complete a procedure for financial transactions by requesting consultation with a bank teller when the customer forgot information or does not know information or procedure for financial transactions using an ATM

### SUMMARY

According to an aspect of the present invention, there is provided an automated teller machine (ATM) including a financial transaction input unit to receive input of a financial transaction request, a first communication unit to communicate with a first server to process at least part of a plurality of steps corresponding to the financial transaction request, a consulting service input unit to receive input of a request for a consulting service associated with the financial transaction request in the plurality of steps, an identification unit to identify a step in which the request for the consulting service is input in response to the consulting service request among the steps, a generation unit to generate financial transaction information corresponding to the identified step, and a second communication unit to request a consulting service associated with the identified step to a second server based on the financial transaction information.

The financial transaction information includes information about the financial transaction request and information about a step before the identified step.

The second communication unit includes a transmission and reception unit to transmit and receive at least one of image data and audio data for video consultation.

The second communication unit includes an interface for sharing a screen of the ATM on a screen of a terminal of a bank teller.

The second communication unit includes an interface for a bank teller to remotely control steps of processing the financial transaction request.

The second communication unit includes a temporary information transmission unit to transmit temporary information input in the identified step to the second server and an identification signal reception unit to receive an identification signal with respect to the temporary information from the second server, and the first communication unit includes a processing information transmission unit to transmit processing information for processing the identified step to the first server based on the temporary information and the identification signal.

The ATM further includes a categorization unit to classify the financial transaction request according to category, and the second communication unit requests a consulting service associated with a category that needs help from a bank teller to the second server when the financial transaction request is classified as the category that needs help from the bank teller.

The ATM further includes a card issuing unit to issue a card.

The second communication unit includes at least one of an interface for transmitting and receiving at least one of image data and audio data for video consultation, an interface for sharing a screen of the ATM on a screen of a terminal of the bank teller, and an interface for the bank teller to remotely control steps of processing the financial transaction request.

The consulting service associated with the identified step includes a consulting service associated with a step after the identified step among the steps.

The consulting service input unit receives input of a consulting service termination request to finish the consulting service associated with the identified step after the consulting service associated with the identified step is provided, and the second communication unit requests termination of the consulting service associated with the identified step to the second server in response to the consulting service termination request.

According to an aspect of the present invention, there is provided a transaction method using an ATM, the transaction method including receiving input of a financial transaction request, communicating with a first server to process at least part of a plurality of steps corresponding to the financial transaction request, receiving input of a request for a consulting service associated with the financial transaction request in the plurality of steps, identifying a step in which the request for the consulting service is input in response to the consulting service request among the steps, generating financial transaction information corresponding to the identified step, and requesting a consulting service associated with the identified step to a second server based on the financial transaction information.

The requesting of the consulting service associated with the identified step to the second server based on the financial transaction information includes requesting information for sharing a screen of the ATM on a screen of a terminal of a bank teller.

The requesting of the consulting service associated with the identified step to the second server based on the financial transaction information includes requesting a signal for a bank teller to remotely control steps of processing the financial transaction request.

The receiving of the input of the financial transaction request includes classifying the financial transaction request according to category, and the requesting of the consulting service associated with the identified step to the second server based on the financial transaction information includes requesting a consulting service associated with a category that needs help from a bank teller to the second server when the financial transaction request is classified as the category that needs help from the bank teller.

The requesting of the consulting service associated with the identified step to the second server based on the financial transaction information includes at least one of requesting at least one of image data and audio data for video consultation, requesting a signal for the bank teller to remotely control steps of processing the financial transaction request, and requesting the consulting service associated with the category that needs help from the bank teller to the second server when the financial transaction request is classified as the category that needs help from the bank teller.

A non-transitory computer-readable recording medium records a program to implement the method.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates an automated teller machine (ATM) enabling remote control or video consultation according to an exemplary embodiment;

FIG. 2 illustrates a second communication unit of the ATM according to the exemplary embodiment;

FIG. 3 illustrates connections between the ATM, a first server, a second server and a terminal of a bank teller according to an exemplary embodiment;

FIG. 4 illustrates remote control of the ATM or video consultation in the ATM via the terminal of the bank teller according to an exemplary embodiment;

FIG. 5 illustrates details displayed on a display of the ATM according to an exemplary embodiment;

FIG. 6 illustrates a transaction method using the ATM according to an exemplary embodiment; and

FIG. 7 illustrates a transaction method including categorizing inputs to the ATM according to an exemplary embodiment.

### DETAILED DESCRIPTION

Hereinafter, exemplary embodiments will be described in detail with reference to the accompanying drawings.

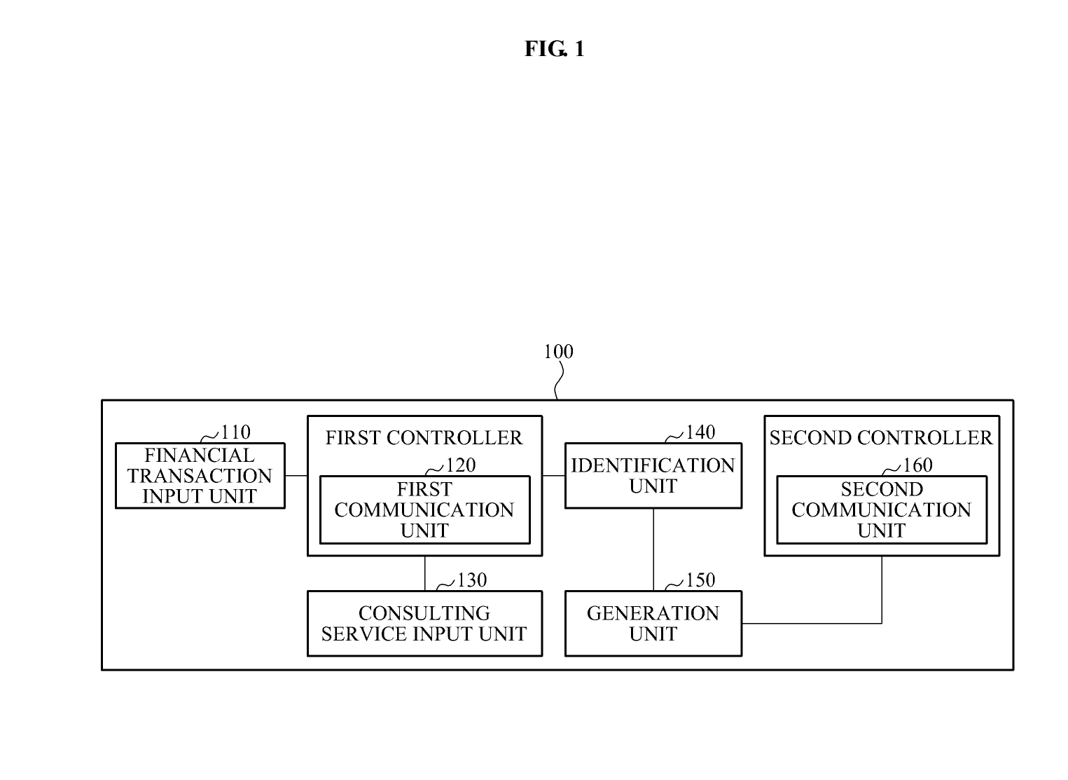

FIG. 1 illustrates an automated teller machine (ATM) enabling remote control or video consultation according to an exemplary embodiment.

Referring to FIG. 1, the ATM according the exemplary embodiment includes a financial transaction input unit 110, a first communication unit 120, a consulting service input unit 130, an identification unit 140, a generation unit 150 and a second communication unit 160.

The input unit 110 is a part to receive input of a financial transaction request. In one embodiment, the financial transaction request may include requests of account holders for depositing, withdrawing and transferring money using the ATM. Also, the financial transaction request may include requests for opening an account, issuing a card, Internet banking, mobile banking, loan consulting, insurance consulting, financial product consulting or issuing a certificate for client identification in financial transactions, for example, an accredited certificate.

The first communication unit 120 communicates with a first server to process at least part of a plurality of steps corresponding to the financial transaction request. A customer goes through a plurality of predetermined stages for a financial transaction using the ATM, which is defined as a plurality of steps. For example, to withdraw money, a customer applies for a withdrawal to the ATM, inserts a card into the ATM, enters a password, checks withdrawal amount and account balance, and finishes the withdrawal transaction.

The first communication unit 120 may be controlled by a first controller.

The consulting service input unit 130 receives input of a request for a consulting service associated with the financial transaction request in the plurality of steps. In one embodiment, the request for the consulting service may be made by touching a tele-consultation or consulting request when a display of the ATM is a touchscreen.

Further, when the ATM has a voice recognition system, a tele-consultation or consulting request may be made via voice input.

In addition, a separate tele-consultation or consulting request button may be installed on the ATM. The consulting service request from a customer may be made not only via tele-consultation or consulting request expressions or voice recognition set in advance but via equivalents thereof.

In one embodiment, when a customer forgot a password for an account in making a withdrawal using the ATM, the customer may request a consulting service. When the consulting service is connected, a bank teller may notify the customer of the password after authentication of the customer or allow the customer to set a new password.

The identification unit 140 identifies a step in which the request for the consulting service is input in response to the consulting service request among the steps.

In one embodiment, when the customer forgot the password for the account in making a withdrawal using the ATM and thus requests the consulting service, the request for the consulting service is made in a step of inputting the password among the steps, and accordingly the identification unit 140 identifies the step of inputting the password.

The generation unit 150 generates financial transaction information corresponding to the identified step.

The financial transaction information may include information about the financial transaction request and information about a step before the identified step.

In one embodiment, when the customer forgot the password for the account in making a withdrawal using the ATM and thus requests the consulting service, information about the withdrawal and information about a step before the step of inputting the password may be generated by the generation unit 150.

The second communication unit 160 requests a consulting service associated with the identified step to a second server based on the financial transaction information.

The second communication unit 160 may be controlled by a second controller.

Although the first communication unit 120 and the second communication unit 160 are shown separately, the communication units 120 and 160 may not be physically separated but combined into one communication unit.

In one embodiment, the ATM may further include a categorization unit (not shown) to classify financial transaction request types. When the categorization unit classifies a financial transaction request as a type that needs help from a bank teller, the second communication unit 160 may request a consulting service associated with the type that need help from the bank teller to the second server.

In one embodiment, the ATM may further include a card issuing unit (not shown) to issue a card. For example, when the customer opens an account and applies for a debit card using the ATM, the customer may receive the debit card through the card issuing unit. Further, when the customer applies for a credit card using the ATM, the customer may receive the credit card through the card issuing unit.

In one embodiment, a service associated with the identified step of the ATM may include a consulting service associated with a step after the identified step among the steps.

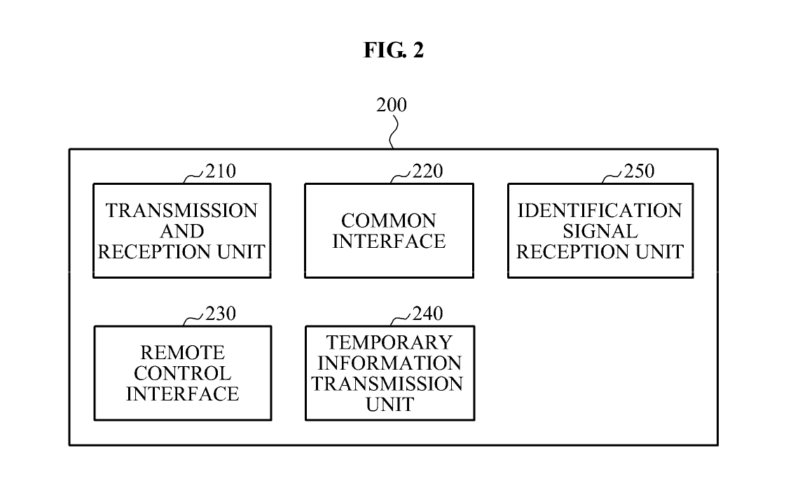

FIG. 2 illustrates the second communication unit of the ATM according to an exemplary embodiment.

Referring to FIG. 2, the second communication unit of the ATM according to the present embodiment may include a transmission and reception unit 210, a common interface 220, a remote control interface 230, a temporary information transmission unit 240 and an identification signal reception unit 250.

The transmission and reception unit 210 transmits and receives at least one of image data and audio data for video consultation.

The common interface 220 is for sharing a screen of the ATM on a screen of a terminal of the bank teller. In one embodiment, the common interface 220 is provided to display details displayed on the display of the ATM on the display of the terminal of the bank teller and to synchronize the displays when a customer requests a consulting service during a financial transaction.

The remote control interface 230 is used for the bank teller to remotely control steps of processing the financial transaction request.

The temporary information transmission unit 240 transmits temporary information input in the identified step among the steps to the second server.

The identification signal reception unit 250 receives an identification signal with respect to the temporary information from the second server.

In one embodiment, when the customer forgot the password for the account in making a withdrawal using the ATM and thus requests a consulting service on the password, the temporary information transmission unit 240 may transmit temporary information including information used to identify the customer, such as a resident registration number of the customer, to the second server.

The bank teller receives the temporary information from the second server to identify the customer. When the customer is identified, the bank teller may transmit an identification signal or data to the second server. The customer receives the identification signal or data through the identification signal reception unit 250 and conducts a predetermined procedure, for example, setting a new password.

In one embodiment, although FIG. 2 does not show the first communication unit, the first communication unit may include a processing information transmission unit to transmit processing information for processing the identified step to the first server based on the temporary information and identification signal.

For example, the customer may set a new password based on the information used to identify the customer when the customer forgot the password and a signal for operating a predetermined procedure, such as setting a new password, and the processing information transmission unit of the first communication unit may transmit the new password to the first server after inputting the new password.

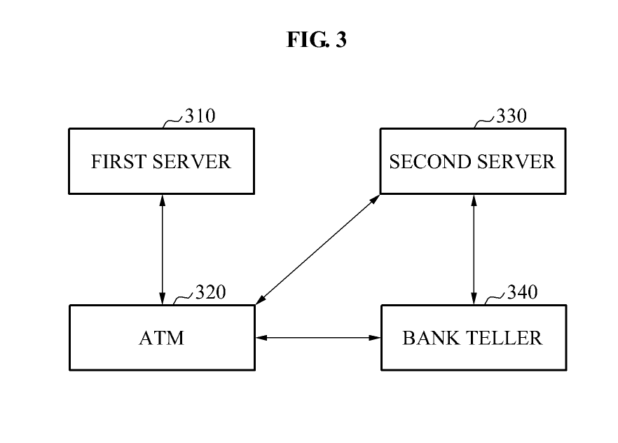

FIG. 3 illustrates connections between a first server 310, an ATM 320, a second server 330 and a bank teller 340 according to an exemplary embodiment. The bank teller may include a terminal of the bank teller.

In one embodiment, when the customer inserts a card into the ATM 320 to apply for a withdrawal through the ATM 320, financial transaction information including information on the card of the customer is transmitted to the first server 310.

When the customer requests a consulting service, the ATM 320 transmits and receives information about the consulting to the second server 330. The customer is connected to the bank teller 340 through the second server 330, and the bank teller 340 may provide video consultation to the customer and support the financial transaction request of the customer via remote control.

When the customer receives support for the financial transaction request via video consultation or remote control, the consulting service input unit 130 of FIG. 1 may receive input of a consulting service termination request to finish the consulting service associated with the identified step after the consulting service associated with the identified step is provided. The second communication unit 160 of FIG. 1 may request termination of the consulting service associated with the identified step to the second server 330 in response to the consulting service termination request.

When the consulting service terminates, the ATM 320 may transmit information about the financial transaction request to the first server 310 to deal with remaining processes of the financial transaction request from the customer.

In one embodiment, there is a financial transaction using the ATM that involves help from the bank teller from the start, for example, opening an account or consulting on a financial product.

Although not shown in FIG. 1, the ATM may further include a categorization unit to classify financial transaction request types.

The categorization unit may classify financial transaction requests into a type that needs help from the bank teller and a type that does not need help. The type that needs help from the bank teller includes opening an account, issuing a card, Internet banking, mobile banking, loan consulting, insurance consulting, financial product consulting or issuing a certificate for client identification in financial transactions, for example, an accredited certificate.

The second communication unit 160 may include at least one of an interface for transmitting and receiving at least one of image data and audio data for video consultation, an interface for sharing the screen of the ATM on the screen of the terminal of the bank teller, and an interface for the bank teller to remotely control the steps of processing the financial transaction request.

The first server 310 and the second server 330 may be controlled by a central server. The first server 310 and the second server 330 may be placed at physically separated locations. For example, when the ATM is installed outside the bank, the first server 310 may be installed at a location other than the bank and the second server 330 may be installed inside or outside the bank.

The first server 310 and the second server 330 may be installed in the same location. When a problem occurs in the ATM in the bank and thus the bank teller receives a request for a consulting service, the first server 310 and the second server 330 may be included in a server in the bank.

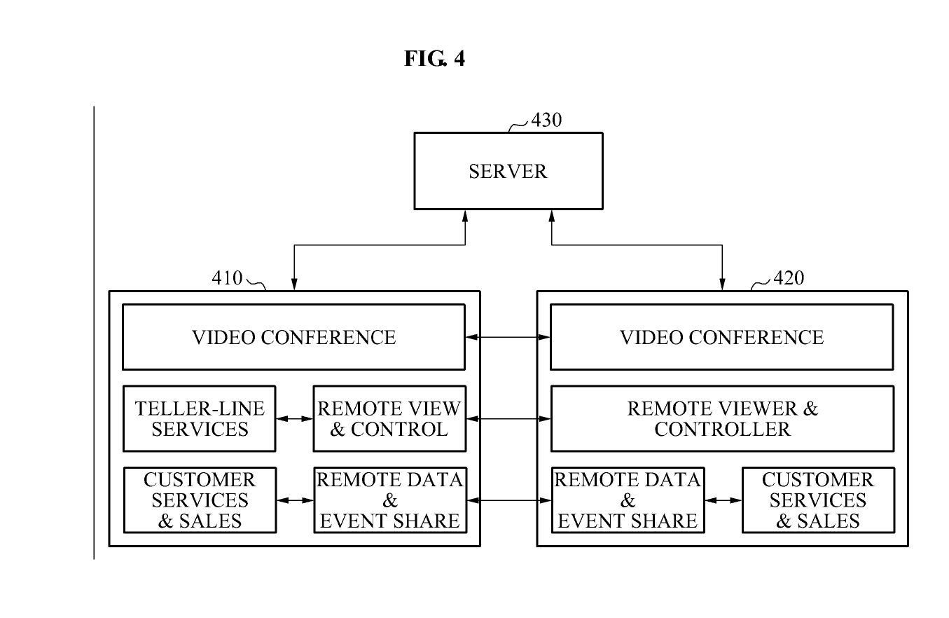

FIG. 4 illustrates remote control of the ATM by the bank teller or video consultation in the ATM with the bank teller according to an exemplary embodiment.

An AMT 410 and a bank teller 420 are connected via a server. The bank teller 420 may include a terminal of the bank teller.

When a customer makes a request for a consulting service or a request for a financial transaction that involves help from the bank teller from the start, the ATM 410 is connected to the bank teller 420 through the server 430.

When the ATM 410 is connected to the bank teller 420 through the server 430, a screen of the ATM 410 may be shared with the bank teller 420 on a screen of the terminal of the bank teller 420. The bank teller 420 may support the request for the financial transaction by remotely controlling the ATM 410 and remotely aid the customer in a procedure of the financial transaction, sharing the screen. The bank teller 420 may remotely see and control the screen of the ATM 410.

The screen of the ATM 410 and the screen of the terminal of the bank teller 420 may be synchronized by sharing information on the customer or an event with respect to the request for the consulting service.

The server 430 may conduct a video conference and system management. The server 430 may store audio data or image data and monitor operations or activities of the ATM 410. The server 430 may conduct system or user authentication and call distribution and monitoring. The server 430 may save a session and restart transactions.

The server 430 may be a different server physically separated from the first server 310 or the second server 330 of FIG. 3 or be included in the same server.

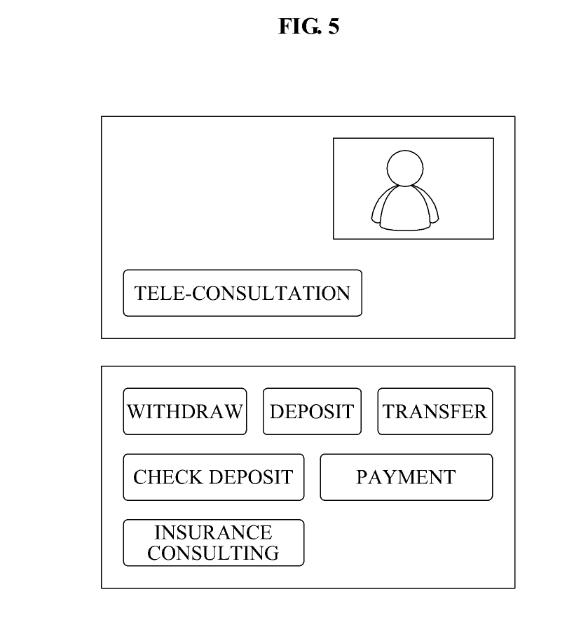

FIG. 5 illustrates details displayed on a display of an ATM according to an exemplary embodiment. Referring to FIG. 5, the display of the ATM according to the present embodiment may include a dual-touchscreen. An upper display displays a tele-consultation to touch to request a consulting service, and an image of a bank teller when video conferencing is connected. When video conferencing is impossible, the bank teller may remotely control the ATM.

A lower display displays various financial transactions, such as not only withdraw, deposit and fund transfer but insurance consulting that involves help from the bank teller. The financial transactions are not limited to those displayed on the lower display of FIG. 5.

The screen of the ATM may include a single screen, and a number of displays of the ATM is not limited to that shown in FIG. 5.

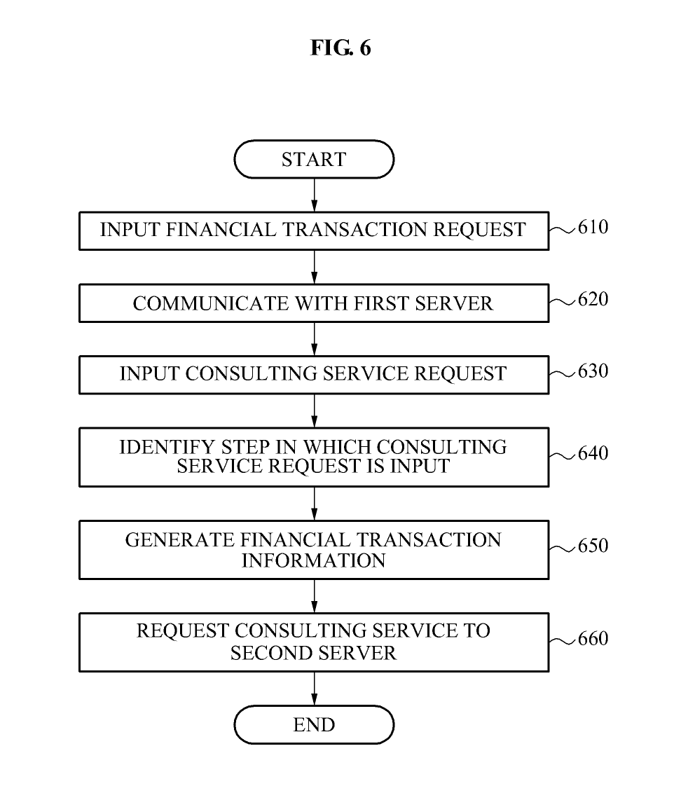

FIG. 6 illustrates a transaction method using an ATM according to an exemplary embodiment. The ATM receives input of a financial transaction request in operation 610.

The ATM communicates with the first server 310 to process at least part of a plurality of steps corresponding to the financial transaction request in operation 620.

The ATM receives input of a request for a consulting service associated with the financial transaction request in the steps in operation 630.

The ATM identifies a step in which the request for the consulting service is input in response to the request for the consulting service among the steps in operation 640.

The ATM generates financial transaction information corresponding to the identified step in operation 650.

The ATM requests the consulting service associated with the identified step to the second server 330 based on the financial transaction information in operation 660.

In one embodiment, the requesting of the consulting service associated with the identified step to the second server 330 based on the financial transaction information may further include requesting at least one of image data and audio data for video consultation. The method may include requesting information for sharing a screen of the ATM on a screen of a terminal of a bank teller. The method may include requesting a signal for the bank teller to remotely control steps of processing the financial transaction request.

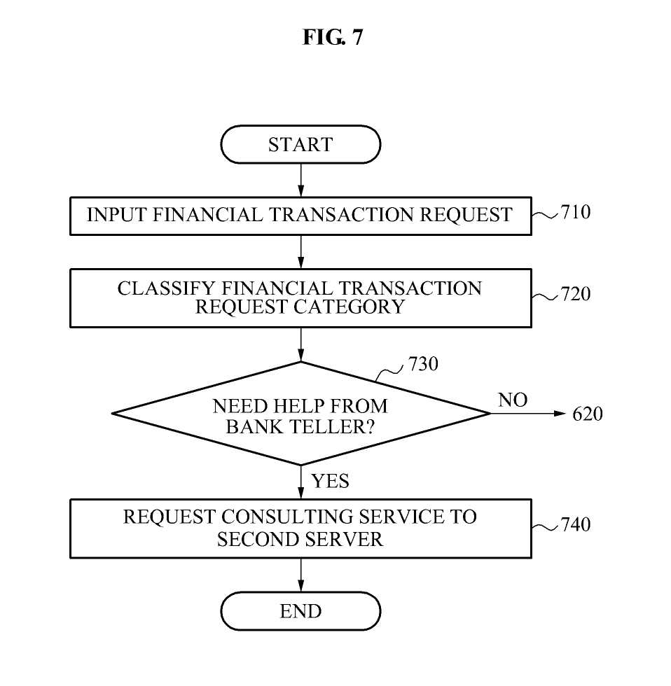

FIG. 7 illustrates a financial transaction method including categorizing inputs to an ATM according to an exemplary embodiment.

According to the present embodiment, operation 610 of FIG. 6 may include classifying financial transaction requests into categories in operation 720.

The financial transaction requests may be classified into a type that needs help from a bank teller and a type that does not need help in operation 730. When a financial transaction request is a type that does not need help from the bank teller, operation 620 of FIG. 6 is carried out. The type that does not need help from the bank teller may be, for example, withdrawing or depositing money.

When a financial transaction request is a type that needs help from the bank teller, a customer requests a consulting service to the second server 330 in operation 740.

The request for the consulting service from the customer may be made by pressing a tele-consultation or consulting request section or button displayed on the ATM. When the financial transaction request that needs help from the bank teller is input, the ATM may automatically request a consulting service to the second server 330 even though the customer does not press the tele-consultation or consulting request section or button.

In one embodiment, when the customer uses online banking using the ATM, this online banking is a financial transaction that needs help from the bank teller. Online banking may include a procedure of identifying the customer, for example, by inputting a residence registration number. The ATM requests a consulting service to the second server 330 and automatically connects to the bank teller via video conferencing. The customer fills in an online banking application form under the guidance of the bank teller and is given an online banking identification (ID) and a password.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Thus, other implementations, alternative embodiments and equivalents to the claimed subject matter are construed as being within the appended claims.

What is claimed is:

1. An automated teller machine (ATM) comprising:
a financial transaction input unit to receive input of a financial transaction request;
a first communication unit to communicate with a first server to process at least part of a plurality of steps corresponding to the financial transaction request;
a consulting service input unit to receive input of a request for a consulting service associated with the financial transaction request in the plurality of steps;
an identification unit to identify a step in which the request for the consulting service is input in response to the consulting service request among the steps;
a generation unit to generate financial transaction information corresponding to the identified step; and
a second communication unit to request a consulting service associated with the identified step to a second server based on the financial transaction information.

2. The ATM of claim 1, wherein the financial transaction information comprises information about the financial transaction request and information about a step before the identified step.

3. The ATM of claim 1, wherein the second communication unit comprises a transmission and reception unit to transmit and receive at least one of image data and audio data for video consultation.

4. The ATM of claim 1, wherein the second communication unit comprises an interface for sharing a screen of the ATM on a screen of a terminal of a bank teller.

5. The ATM of claim 1, wherein the second communication unit comprises an interface for a bank teller to remotely control steps of processing the financial transaction request.

6. The ATM of claim 1, wherein the second communication unit comprises a temporary information transmission unit to transmit temporary information input in the identified step to the second server and an identification signal reception unit to receive an identification signal with respect to the temporary information from the second server, and the first communication unit comprises a processing information transmission unit to transmit processing information for processing the identified step to the first server based on the temporary information and the identification signal.

7. The ATM of claim 1, further comprising a categorization unit to classify the financial transaction request according to category, wherein the second communication unit requests a consulting service associated with a category that needs help from a bank teller to the second server when the financial transaction request is classified as the category that needs help from the bank teller.

8. The ATM of claim 7, wherein the second communication unit comprises at least one of an interface for transmitting and receiving at least one of image data and audio data for video consultation, an interface for sharing a screen of the ATM on a screen of a terminal of the bank teller, and an interface for the bank teller to remotely control steps of processing the financial transaction request.

9. The ATM of claim 1, wherein the consulting service associated with the identified step comprises a consulting service associated with a step after the identified step among the steps.

10. The ATM of claim 1, wherein the consulting service input unit receives input of a consulting service termination request to finish the consulting service associated with the identified step after the consulting service associated with the identified step is provided, and the second communication unit requests termination of the consulting service associated with the identified step to the second server in response to the consulting service termination request.

11. A transaction method using an automated teller machine (ATM), the transaction method comprising:
receiving input of a financial transaction request;
communicating with a first server to process at least part of a plurality of steps corresponding to the financial transaction request;
receiving input of a request for a consulting service associated with the financial transaction request in the plurality of steps;
identifying a step in which the request for the consulting service is input in response to the consulting service request among the steps;
generating financial transaction information corresponding to the identified step; and
requesting a consulting service associated with the identified step to a second server based on the financial transaction information.

12. The transaction method of claim 11, wherein the requesting of the consulting service associated with the identified step to the second server based on the financial transaction information comprises requesting at least one of image data and audio data for video consultation.

13. The transaction method of claim 11, wherein the requesting of the consulting service associated with the identified step to the second server based on the financial transaction information comprises requesting information for sharing a screen of the ATM on a screen of a terminal of a bank teller.

14. The transaction method of claim 11, wherein the requesting of the consulting service associated with the identified step to the second server based on the financial transaction information comprises requesting a signal for a bank teller to remotely control steps of processing the financial transaction request.

15. The transaction method of claim 11, wherein the receiving of the input of the financial transaction request comprises classifying the financial transaction request according to category, and the requesting of the consulting service associated with the identified step to the second server based on the financial transaction information comprises requesting a consulting service associated with a category that needs help from a bank teller to the second server when the financial transaction request is classified as the category that needs help from the bank teller.

16. The transaction method of claim 15, wherein the requesting of the consulting service associated with the identified step to the second server based on the financial transaction information comprises at least one of requesting at least one of image data and audio data for video consultation, requesting a signal for the bank teller to remotely control steps of processing the financial transaction request, and requesting the consulting service associated with the category that needs help from the bank teller to the second server when the financial transaction request is classified as the category that needs help from the bank teller.

17. A non-transitory computer-readable recording medium to record a program to implement the method of claim 11.
